(19) United States
(12) Patent Application Publication
(10) Pub. No.: US 2024/0110425 A1
(43) Pub. Date: Apr. 4, 2024

(54) VEHICLE DOOR CONTROL DEVICE

(71) Applicant: AISIN CORPORATION, Kariya (JP)

(72) Inventors: Taishi IIKAWA, Kariya-shi (JP); Masafumi SUZUKI, Kariya-shi (JP); Gen TAKATSUKA, Kariya-shi (JP); Ayaka SHIMIZU, Kariya-shi (JP); Hiroki EBA, Kariya-shi (JP); Takayuki SENGOKU, Kariya-shi (JP)

(73) Assignee: AISIN CORPORATION, Kariya (JP)

(21) Appl. No.: 18/475,462

(22) Filed: Sep. 27, 2023

(30) Foreign Application Priority Data
Sep. 29, 2022 (JP) 2022-156899

(51) Int. Cl. E05F 15/611

(52) U.S. Cl. CPC E05F 15/611; E05Y 2400/302; E05Y 2400/36; E05Y 2400/40; E05Y 2400/45; E05Y 2900/532

(57) ABSTRACT

A vehicle door control device is provided to a vehicle including a door and a drive device. The vehicle door control device executes door control processing when the door moves in a closing direction from a stopped state in a state where a closing operation command signal for commanding a closing operation of the door is not received. In the door control processing, the vehicle door control device executes a braking mode, in which a braking force is applied to the door by regenerative braking action of a motor, when the door opening degree is less than the determination opening degree, and executes a closing operation mode, in which the door performs the closing operation such that a moving speed of the door is constant, when the door opening degree is equal to or greater than the determination opening degree.

### TECHNICAL FIELD

### Cross Reference to Related Applications

This application is based on and claims priority under 35 U.S.C. § 119 to Japanese Patent Application 2022-156899, filed on Sep. 29, 2022, the entire content of which is incorporated herein by reference.

This disclosure relates to a vehicle door control device.

### BACKGROUND DISCUSSION

JPH10-246061A (Reference 1) discloses an automatic sliding door device that opens and closes a door opening of a vehicle body by a drive device using a motor as a driving source.

In the device disclosed in Reference 1, an operation of the motor of the drive device is controlled in order to reduce an opening/closing speed of a sliding door when the sliding door slides down due to its own weight. In the device, the opening/closing speed of the sliding door is controlled by alternately switching a state of the motor between a regenerative braking state and a free state in which regenerative braking is not applied. By such control, safety of the surroundings at the time when the sliding door is driven to open and close is secured.

In a vehicle door such as a back door that rotates about a rotation axis extending along an upper edge of a door opening, a posture of the door in an open state is maintained by biasing the door in an opening direction by a drive device. When the door is in the open state, an external force generated due to an own weight of the door or a manual operation of an occupant acts on the door, and thus the door may move in a closing direction about the rotation axis, that is, the door may descend. In this case, in the door whose moving speed is controlled by a regenerative brake of the motor, a load acting on the drive device may increase. Therefore, it is desired to secure safety of the surroundings at the time when the door descends and reduce the load acting on the drive device.

Such problems are not limited to the back door, and similarly occur in a door that opens and closes a door opening on a front surface or a side surface of a vehicle body as long as the door rotates around a rotation axis extending along an upper edge of the door opening.

### SUMMARY

According to an aspect of this disclosure, a vehicle door control device is provided that is applied to a vehicle including a door and a drive device, the door being configured to open and close a door opening of a vehicle body by rotating about a rotation axis extending along an upper edge of the door opening, and the drive device including a motor configured to drive the door to open and close, the vehicle door control device controlling driving of the motor. A door opening degree between a door opening degree of the door in a fully open state and a door opening degree of the door in a fully closed state is defined as a determination opening degree. The vehicle door control device executes door control processing when the door moves in a closing direction from a stopped state in a state where a closing operation command signal for commanding a closing operation of the door is not received. In the door control processing, the vehicle door control device executes a braking mode, in which a braking force is applied to the door by regenerative braking action of the motor, when the door opening degree is less than the determination opening degree, and executes a closing operation mode, in which the door performs the closing operation such that a moving speed of the door is constant, when the door opening degree is equal to or greater than the determination opening degree.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic diagram illustrating a schematic configuration of a vehicle including a vehicle door control device according to an embodiment;

FIG. 2 is a schematic diagram illustrating a configuration of the door control device and a drive device in FIG. 1;

FIG. 3 is a table showing a driving mode of a motor at the time when a back door in FIG. 1 descends;

FIG. 4 is a table showing a driving mode of the motor at the time of re-descending of the back door in FIG. 1;

FIG. 5 is a flowchart illustrating a procedure of door control processing executed by the door control device in FIG. 1; and

FIG. 6 is a flowchart illustrating a procedure of stop determination processing executed by the door control device in FIG. 1.

### DETAILED DESCRIPTION

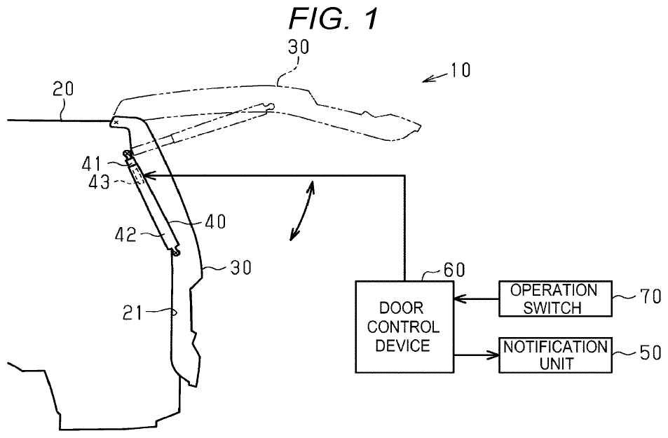

Hereinafter, an embodiment in which a vehicle door control device is embodied as a door control device for a vehicle back door will be described with reference to FIGS. 1 to 6.

As illustrated in FIG. 1, a vehicle 10 includes a vehicle body 20 having a door opening 21 at a rear portion thereof, a back door 30 configured to open and close the door opening 21, and a drive device 40 configured to drive the back door 30 to open and close. The vehicle 10 further includes a notification unit 50 configured to notify an occupant and a person around the vehicle 10 of a warning, and a door control device 60 configured to control the drive device 40 and the notification unit 50.

Back Door 30

The back door 30 is rotatable about a rotation axis extending along an upper edge of the door opening 21. More specifically, the back door 30 is rotatable via a hinge (not shown) including a rotation shaft extending in a vehicle width direction.

As indicated by a solid line and a two-dot chain line in FIG. 1, the back door 30 is displaced between a fully closed position where the back door 30 fully closes the door opening 21 and a fully open position where the back door 30 fully opens the door opening 21.

Drive Device 40

The drive device 40 is provided, for example, at each of portions on both sides of the back door 30 in the vehicle width direction.

The drive device 40 includes an inner cylinder 41, an outer cylinder 42 that accommodates one end of the inner cylinder 41, and a motor 43 provided inside the inner cylinder 41 or the outer cylinder 42. For example, one end portion of the inner cylinder 41 is rotatably supported on the vehicle body 20. For example, one end portion of the outer cylinder 42 is rotatably supported on the back door 30.

A spindle screw (not shown) is provided inside the inner cylinder 41 and the outer cylinder 42. When the spindle screw is rotated by the motor 43 serving as a driving source, the inner cylinder 41 and the outer cylinder 42 are relatively moved in an axial direction. Accordingly, the drive device 40 expands and contracts, whereby the back door 30 is driven to open and close. At the time of expansion, the drive device 40 applies, to the back door 30, a force for causing the back door 30 to perform an opening operation. At the time of contraction, the drive device 40 applies, to the back door 30, a force for causing the back door 30 perform a closing operation.

The drive device 40 constantly biases the back door 30 in an opening direction by a spring (not shown) disposed between the inner cylinder 41 and the outer cylinder 42. Accordingly, the drive device 40 biases the back door 30 in the opening direction even in a state where power supply to the motor 43 is stopped.

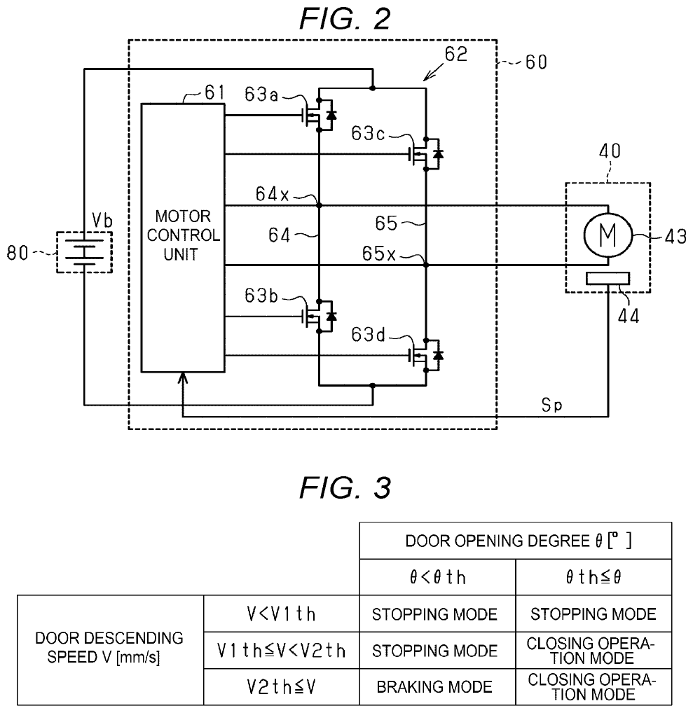

The drive device 40 includes one or more pulse sensors 44 (see FIG. 2) configured to output a pulse signal Sp synchronized with the rotation of the motor 43 to the door control device 60.

Notification Unit 50

The notification unit 50 is provided, for example, in the back door 30 or around the door opening 21 in the vehicle body 20. The notification unit 50 makes a notification of a warning by, for example, sound, light, video, and vibration.

Operation Switch 70

An operation switch 70 outputs, to the door control device 60, an opening operation command signal for commanding the opening operation of the back door 30 and a closing operation command signal for commanding the closing operation of the back door 30. Examples of the operation switch 70 include a switch provided in the back door 30, a vehicle interior, or the like, and a switch provided in a portable device such as an electronic key or a smartphone.

Door Control Device 60

The door control device 60 controls the driving of the motor 43 based on the opening operation command signal received from the operation switch 70 to cause the back door 30 to perform the opening operation. The door control device 60 controls the driving of the motor 43 based on the closing operation command signal received from the operation switch 70 to cause the back door 30 to perform the closing operation.

For example, the door control device 60 detects an opening/closing speed and a door opening degree of the back door 30 based on the pulse signal Sp output from the pulse sensor 44.

As illustrated in FIG. 2, the door control device 60 includes a motor control unit 61 configured to generate a motor control signal, and a drive circuit 62 configured to supply electric power to the motor 43 based on the motor control signal.

As the drive circuit 62, a known PWM inverter is used in which a plurality of switching elements 63a, 63b, 63c, and 63d that are turned on and off based on the motor control signal are connected in an H-bridge manner. For example, field effect transistors (FET) are used as the switching elements 63a, 63b, 63c, and 63d.

The drive circuit 62 has a configuration in which a first switching arm 64 and a second switching arm 65 are connected in parallel. The first switching arm 64 includes the switching elements 63a and 63b connected in series, and the second switching arm 65 includes the switching elements 63c and 63d connected in series. In the drive circuit 62, a power supply voltage Vb of an in-vehicle power supply 80 is applied to the switching elements 63a and 63c of the switching arms 64 and 65, and the switching elements 63b and 63d of the switching arms 64 and 65 are grounded. A connection point 64x between the switching elements 63a and 63b of the first switching arm 64 and a connection point 65x between the switching elements 63c and 63d of the second switching arm 65 are connection points to connection terminals of the motor 43.

When the motor 43 is to be rotated in a first direction, the motor control unit 61 turns on the switching elements 63a and 63d and turns off the switching elements 63b and 63c by outputting the motor control signal. When the motor 43 is to be rotated in a second direction opposite to the first direction, the motor control unit 61 turns on the switching elements 63b and 63c and turns off the switching elements 63a and 63d by outputting the motor control signal. The motor control unit 61 controls a duty ratio of each of the switching elements 63a, 63b, 63c, and 63d through the output of the motor control signal to change a driving force generated by the motor 43.

Door Control Processing

When an external force generated due to an own weight of the back door 30 or a manual operation of an occupant acts on the back door 30 in an open state, the back door 30 may move in the closing direction from a stopped state, that is, the back door 30 may descend (hereinafter, simply referred to as “descending/descent”). The descending of the back door 30 is likely to occur when a force of the drive device 40 supporting the back door 30 is reduced due to a failure or deformation of one of the two drive devices 40 on both sides in the vehicle width direction.

Therefore, when the descending of the back door 30 is detected, the door control device 60 executes door control processing of switching a driving mode of the motor 43 according to a descending mode of the back door 30.

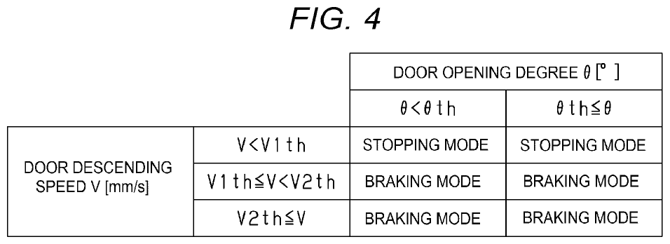

As illustrated in FIGS. 3 and 4, the door control processing is processing of selectively executing a braking mode, a closing operation mode, and a stopping mode according to a closing speed of the back door 30 and the door opening degree of the back door 30 at the time of descending. Hereinafter, the closing speed of the back door 30 at the time of descending is expressed as “door descending speed V”, and the door opening degree of the back door 30 is simply expressed as “door opening degree θ”.

The door control processing is executed when the back door 30 moves in the closing direction from the stopped state in a state where the closing operation command signal for commanding the closing operation of the back door 30 is not input to the door control device 60, that is, when the back door 30 descends.

When the back door 30 in an opening operation descends, since a moving direction of the back door 30 is switched from the opening direction to the closing direction, the back door 30 moves in the closing direction from a temporarily stopped state. Accordingly, the door control device 60 executes the door control processing even when the back door 30 in an opening operation descends.

The door control device 60 detects the door descending speed V and the door opening degree θ based on the pulse signal Sp output from the pulse sensor 44. The door control device 60 determines whether the back door 30 is descending, based on the door descending speed V and the door opening degree θ.

In the braking mode, the motor control unit 61 turns on the switching elements 63a and 63c and turns off the switching elements 63b and 63d, thereby bringing the drive circuit 62 into a regenerative braking state. In the regenerative braking state, since terminals of each phase of the motor 43 are short-circuited, when the motor 43 is rotated by an external force, a back electromotive force is generated in the motor 43. Since the rotation of the motor 43 is hindered by the back electromotive force, a braking force is applied to the back door 30. In the braking mode, the motor control unit 61 may turn on the switching elements 63b and 63d and turn off the switching elements 63a and 63c, thereby bringing the drive circuit 62 into the regenerative braking state.

In the closing operation mode, the back door 30 performs the closing operation such that the moving speed of the back door 30 is constant by PWM control over the motor 43. The moving speed of the back door 30 in the closing operation mode is preferably about the same as the moving speed of the back door 30 in a normal closing operation. The normal closing operation means a closing operation of the back door 30 based on the closing operation command signal received from the operation switch 70.

In the stopping mode, the motor control unit 61 turns off all the switching elements 63a, 63b, 63c, and 63d, thereby stopping the power supply to the motor 43.

As illustrated in FIG. 3, in the door control processing, a determination opening degree θth is set as a determination value of the door opening degree θ at the time of executing the door control processing. The determination opening degree θth is a door opening degree θ between a door opening degree θ in a fully open state and a door opening degree θ in a fully closed state. When the door opening degree θ in the fully closed state is 0°, the determination opening degree θth is set to 10°, for example.

In the door control processing, a first determination speed V1th and a second determination speed V2th larger than the first determination speed V1th are set as determination values of the door descending speed V at the time of executing the door control processing. The first determination speed V1th and the second determination speed V2th are, for example, speeds of an end portion of the back door 30 on the opposite side of the rotation axis. The first determination speed V1th is, for example, smaller than the moving speed of the back door 30 during the normal closing operation. The second determination speed V2th is, for example, larger than the moving speed of the back door 30 during the normal closing operation. The first determination speed V1th is set to 25 mm/s, for example, and the second determination speed V2th is set to 700 mm/s, for example.

In the door control processing, the braking mode is executed when the door opening degree is less than the determination opening degree θth and the door descending speed V is equal to or greater than the second determination speed V2th.

In the door control processing, the stopping mode is executed when the door opening degree θ is less than the determination opening degree θth and the door descending speed V is less than the second determination speed V2th. In the door control processing, the stopping mode is also executed when the door opening degree θ is less than the determination opening degree θth and the door descending speed V is less than the first determination speed V1th.

In the door control processing, the closing operation mode is executed when the door opening degree θ is equal to or greater than the determination opening degree θth and the door descending speed V is equal to or greater than the first determination speed V1th. In the door control processing, the closing operation mode is also executed when the door opening degree θ is equal to or greater than the determination opening degree θth and the door descending speed V is equal to or greater than the second determination speed V2th.

In the door control processing, the stopping mode is executed when the door opening degree θ is equal to or greater than the determination opening degree θth and the door descending speed V is less than the first determination speed V1th.

In the door control processing, these modes are selectively executed according to the door descending speed V and the door opening degree θ at that time. That is, in the door control processing, for example, the mode is shifted from the closing operation mode to the stopping mode or the braking mode, or from the braking mode to the stopping mode.

In a state where no closing operation command signal is received after the back door 30 descended, when it is detected that the back door 30 descends again from a stopped state (hereinafter, simply expressed as “re-descending”), the door control device 60 also executes the door control processing.

In the door control processing in the case of re-descending, regardless of the value of the door opening degree θ, the braking mode is executed when the door descending speed V is equal to or greater than the first determination speed V1th, and the stopping mode is executed when the door descending speed V is less than the first determination speed V1th. In the door control processing in the case of re-descending, the braking mode is also executed when the door descending speed V is equal to or greater than the second determination speed V2th.

When the door control processing is being executed, the door control device 60 operates the notification unit 50 to notify a person around the back door 30 such as an occupant that the door control processing is being executed.

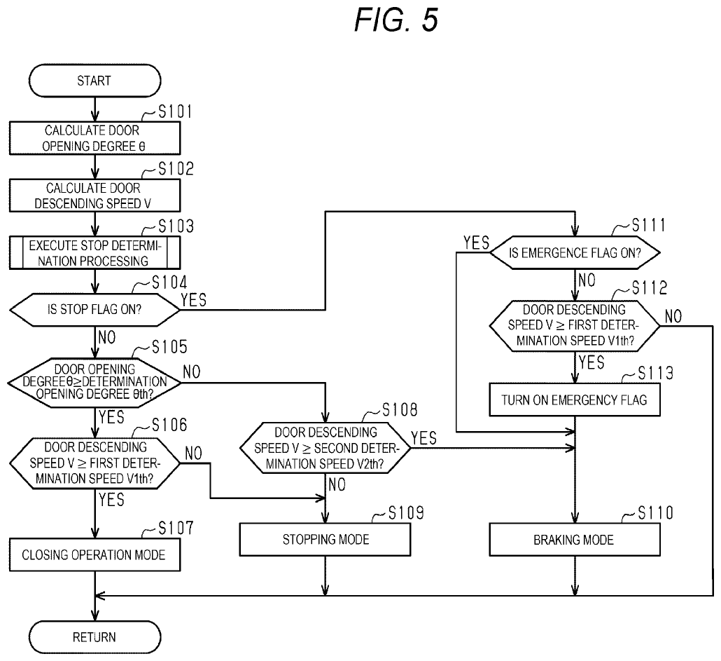

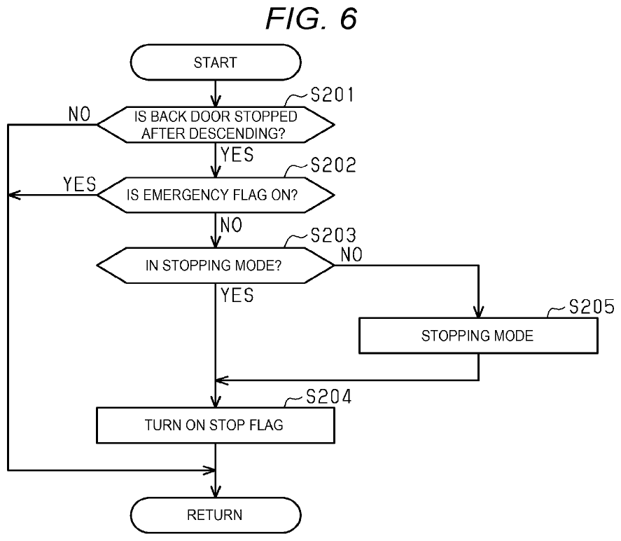

Next, a procedure of the door control processing executed by the door control device 60 will be described with reference to flowcharts shown in FIGS. 5 and 6.

When descending of the back door 30 is detected, the door control device 60 repeatedly executes the door control processing in a predetermined control cycle. The door control device 60 ends the door control processing, for example, when it is detected that a predetermined period of time elapsed from start of the door control processing, that the back door 30 is in the fully closed state, or that the operation switch 70 is operated. An emergency flag and a stop flag described later are flags that are turned off at the start of the door control processing. However, the emergency flag and the stop flag are not turned off during the repeated execution of the door control processing in the predetermined control cycle.

The door control device 60 calculates the door opening degree θ based on an output of the pulse sensor 44 (step S101).

Next, the door control device 60 calculates the door descending speed V based on the output of the pulse sensor 44 (step S102).

Next, the door control device 60 executes stop determination processing of determining whether the back door 30 is stopped (step S103).

As illustrated in FIG. 6, in the stop determination processing, the door control device 60 determines, based on the door opening degree θ and the door descending speed V calculated in steps S101 and S102, whether the back door 30 is stopped after descending (step S201).

When it is determined that the back door 30 is stopped after descending (step S201: YES), the door control device 60 determines whether the emergency flag is on (step S202). Here, the emergency flag is a flag for determining whether the door descending speed V of the back door 30 in the case of re-descending is equal to or greater than the first determination speed V1th. When it is determined that the back door 30 is not stopped after descending (step S201: NO), that is, when the descending of the back door 30 is continuing, the door control device 60 ends the stop determination processing.

When the emergency flag is not on (step S202: NO), the door control device 60 determines whether a driving mode of the motor 43 is the stopping mode (step S203). When the emergency flag is on (step S202: YES), the door control device 60 ends the stop determination processing.

When the driving mode of the motor 43 is the stopping mode (step S203: YES), the door control device 60 turns on the stop flag (step S204) and thereafter ends the stop determination processing. Here, the stop flag is a flag for determining whether the back door 30 is stopped after descending. When the driving mode of the motor 43 is not the stopping mode (step S203: NO), the door control device 60 switches the driving mode of the motor 43 to the stopping mode (step S205). Then, the door control device 60 turns on the stop flag (step S204) and thereafter ends the stop determination processing.

As illustrated in FIG. 5, next, the door control device 60 determines whether the stop flag is on (step S104). When the stop flag is not on (step S104: NO), the door control device 60 determines whether the door opening degree θ is equal to or greater than the determination opening degree θth (step S105).

When the door opening degree θ is equal to or greater than the determination opening degree θth (step S105: YES), the door control device 60 determines whether the door descending speed V is equal to or greater than the first determination speed V1th (step S106).

When the door descending speed V is equal to or greater than the first determination speed V1th (step S106: YES), the door control device 60 executes the closing operation mode (step S107) and thereafter temporarily ends the series of control processing. When the door descending speed V is not equal to or greater than the first determination speed V1th, that is, when the door descending speed V is less than the first determination speed V1th (step S106: NO), the door control device 60 executes the stopping mode (step S109) and thereafter temporarily ends the series of control processing.

On the other hand, when the door opening degree θ is not equal to or greater than the determination opening degree θth, that is, when the door opening degree θ is less than the determination opening degree θth (step S105: NO), the door control device 60 determines whether the door descending speed V is equal to or greater than the second determination speed V2th (step S108).

When the door descending speed V is not equal to or greater than the second determination speed V2th, that is, when the door descending speed V is less than the second determination speed V2th (step S108: NO), the door control device 60 executes the stopping mode (step S109) and thereafter temporarily ends the series of control processing. When the door descending speed V is equal to or greater than the second determination speed V2th (step S108: YES), the door control device 60 executes the braking mode (step S110) and thereafter temporarily ends the series of control processing.

On the other hand, when the stop flag is on in step S104 (step S104: YES), the door control device 60 determines whether the emergency flag is on (step S111).

When the emergency flag is not on (step S111: NO), the door control device 60 determines whether the door descending speed V is equal to or greater than the first determination speed V1th (step S112). When the emergency flag is on (step S111: YES), the door control device 60 executes the braking mode (step S110) and thereafter temporarily ends the series of control processing.

When the door descending speed V is equal to or greater than the first determination speed V1th (step S112: YES), the door control device 60 turns on the emergency flag (step S113). Then, the door control device 60 executes the braking mode (step S110) and thereafter temporarily ends the series of control processing. When the door descending speed V is not equal to or greater than the first determination speed V1th, that is, when the door descending speed V is less than the first determination speed V1th (step S112: NO), the door control device 60 temporarily ends the series of control processing.

Door Control Processing of Back Door 30 in Case of Re-Descending

Next, a procedure of the door control processing of the back door 30 in the case of re-descending will be described. Hereinafter, regarding the procedure of the door control processing, a description overlapping with the content already described may be omitted.

First, a procedure of the door control processing at the time when the back door 30 is stopped immediately before re-descending will be described.

As illustrated in FIG. 6, since the back door 30 immediately before re-descending is in a stopped state after descending, the door control device 60 determines, in the stop determination processing (step S103), that the back door 30 is stopped after descending (step S201: YES).

Next, the door control device 60 determines whether the emergency flag is on (step S202). Since the emergency flag is not on immediately before re-descending of the back door 30, the door control device 60 determines whether the driving mode of the motor 43 is the stopping mode (step S203).

Next, when the driving mode of the motor 43 is the stopping mode (step S203: YES), the door control device 60 turns on the stop flag (step S204), and thereafter ends the stop determination processing. On the other hand, when the driving mode of the motor 43 is not the stopping mode (step S203: NO), the door control device 60 switches the driving mode of the motor 43 to the stopping mode (step S205). Then, the door control device 60 turns on the stop flag (step S204) and thereafter ends the stop determination processing.

As illustrated in FIG. 5, next, after determining that the stop flag is on (step S104: YES), the door control device 60 determines whether the emergency flag is on (step S111). Since the emergency flag is not on immediately before re-descending of the back door 30 (step S111: NO), the door control device 60 determines whether the door descending speed V is equal to or greater than the first determination speed V1th (step S112).

Since the back door 30 is in a stopped state immediately before re-descending, the door descending speed V is less than the first determination speed V1th (step S112: NO). Accordingly, the door control device 60 temporarily ends the series of door control processing. In this case, the door control device 60 continues to execute the stopping mode.

Next, a procedure of the door control processing at the time when the back door 30 re-descends will be described.

Since the stop flag is already on when the back door 30 re-descends, the door control device 60 determines that the stop flag is on (step S104: YES) and thereafter determines whether the emergency flag is on (step S111).

When the emergency flag is not on (step S112: NO), the door control device 60 determines whether the door descending speed V is equal to or greater than the first determination speed V1th (step S112). When the door descending speed V is equal to or greater than the first determination speed V1th (step S112: YES), the door control device 60 turns on the emergency flag (step S113). Then, the door control device 60 executes the braking mode (step S110) and thereafter temporarily ends the series of control processing. When the door descending speed V is less than the first determination speed V1th (step S112: NO), the door control device 60 temporarily ends the series of control processing. In this case, the door control device 60 continues to execute the stopping mode.

When the braking mode is executed at least once during re-descending of the back door 30, in the door control processing to be repeated thereafter, the stop flag and the emergency flag are constantly on as long as re-descending of the back door 30 continues. Therefore, the door control device 60 continues to execute the braking mode as long as re-descending of the back door 30 continues.

Operations and effects of the embodiment will be described.
(1) The door control device 60 executes the closing operation mode when the door opening degree θ is equal to or greater than the determination opening degree θth and the door descending speed V is equal to or greater than the first determination speed V1th. The door control device 60 executes the stopping mode when the door opening degree θ is equal to or greater than the determination opening degree θth and the door descending speed V is less than the first determination speed V1th.

According to such a configuration, when the door opening degree θ is equal to or greater than the determination opening degree θth and the door descending speed V is equal to or greater than the first determination speed V1th, it is determined highly necessary to prevent the acceleration of the descending back door 30, and the back door 30 performs the closing operation such that a moving speed thereof is constant. Accordingly, even when an own weight or an external force acts on the back door 30 that performs the closing operation, since the back door 30 moves in the closing direction at a constant speed, sudden acceleration in the closing direction of the back door 30 can be prevented. Accordingly, as compared to a case where a braking force is applied to the back door 30 by regenerative braking action of the motor 43, it is possible to reduce a load acting on the drive device 40 while securing the safety of the surroundings during descending of the back door 30.

When the door opening degree θ is equal to or greater than the determination opening degree θth and the door descending speed V is less than the first determination speed V1th, it is determined that a force causing the back door 30 to descend is small, and the power supply to the motor 43 is stopped. In a state where the power supply to the motor 43 is stopped, the back door 30 is biased in the opening direction by the drive device 40. Therefore, when the force causing the back door 30 to descend is smaller than a biasing force of the drive device 40, a posture of the back door 30 is maintained. On the other hand, when the force causing the back door 30 to descend is greater than the biasing force of the drive device 40, the back door 30 moves in the closing direction against the biasing force. Accordingly, the load acting on the drive device 40 can be reduced as compared with the case where a braking force is applied to the back door 30 by the regenerative braking action of the motor 43.

As described above, when the door opening degree θ is equal to or greater than the determination opening degree θth, the first determination speed V1th is set as a threshold, and it is possible to secure the safety of the surroundings during descending of the back door 30 and reduce the load acting on the drive device 40.
(2) The door control device 60 executes the braking mode when the door opening degree is less than the determination opening degree θth and the door descending speed V is equal to or greater than the second determination speed V2th. The door control device 60 executes the stopping mode when the door opening degree θ is less than the determination opening degree θth and the door descending speed V is less than the second determination speed V2th.

According to this configuration, when the door opening degree θ is less than the determination opening degree θth and the door descending speed V is equal to or greater than the second determination speed V2th, it is determined highly necessary to decelerate the back door 30, and a braking force is applied to the back door 30 moving in the closing direction. Therefore, it is possible to prevent the back door 30 from continuously descending. Accordingly, the safety of the surroundings during descending of the back door 30 can be secured.

When the door opening degree θ is less than the determination opening degree θth and the door descending speed V is less than the second determination speed V2th, it is determined not so highly necessary to decelerate the back door 30, and the power supply to the motor 43 is stopped. Accordingly, the load acting on the drive device 40 can be reduced as compared with the case where a braking force is applied to the back door 30 by the regenerative braking action of the motor 43.

As described above, when the door opening degree θ is less than the determination opening degree θth, the second determination speed V2th is set as a threshold, and it is possible to both secure the safety of the surroundings during descending of the back door 30 and reduce the load acting on the drive device 40.
(3) The door control device 60 executes the braking mode when the back door 30 re-descends and the door descending speed V is equal to or greater than the first determination speed V1th.

According to this configuration, a braking force is applied to the back door 30 that re-descends. Therefore, even when the back door 30 that is stopped once re-descends due to its own weight, an external force, or the like, it is possible to secure safety of the surroundings during descending of the back door 30.
(4) When the door control processing is being executed, the door control device 60 operates the notification unit 50.

According to such a configuration, a person around the back door 30 is notified that the door control processing is being executed. Therefore, it is possible to alert a person around the back door 30 to the back door 30 that may move in the closing direction.

The embodiment can be modified as follows. The embodiment and the following modifications can be implemented in combination with each other within a range of not technically contradicting each other.

The door control device 60 may not cause the notification unit 50 to notify that the door control processing is executed.

When the back door 30 re-descends, the door control device 60 may execute the same door control processing as that executed when the back door 30 descends.

After the execution of the braking mode in the case of re-descending of the back door 30, when the door descending speed V becomes less than the first determination speed V1th, the door control device 60 may execute the stopping mode.

The door control device 60 may not execute the door control processing in the case of re-descending of the back door 30.

When the door opening degree θ is less than the determination opening degree θth, the door control device 60 may execute the braking mode regardless of a value of the door descending speed V. In this case, when the door opening degree θ is equal to or greater than the determination opening degree θth, the door control device 60 may drive the motor 43 in the same driving mode as in the above-described embodiment.

When the door opening degree θ is equal to or greater than the determination opening degree θth, the door control device 60 may execute the closing operation mode regardless of the value of the door descending speed V. In this case, when the door opening degree θ is less than the determination opening degree θth, the door control device 60 may drive the motor 43 in the same driving mode as in the above-described embodiment.

The door control device 60 may execute the braking mode when the door opening degree is less than the determination opening degree θth and the door descending speed V is equal to or greater than the first determination speed V1th. In addition, the door control device 60 may execute the stopping mode when the door opening degree θ is less than the determination opening degree θth and the door descending speed V is less than the first determination speed V1th.

The door control device 60 may execute the closing operation mode when the door opening degree θ is equal to or greater than the determination opening degree θth and the door descending speed V is equal to or greater than the second determination speed V2th. In addition, the door control device 60 may execute the stopping mode when the door opening degree θ is equal to or greater than the determination opening degree θth and the door descending speed V is less than the second determination speed V2th.

Values of the respective determination opening degree θth, first determination speed V1th, and second determination speed V2th can be appropriately changed according to a shape and a specification of the vehicle.

The vehicle 10 may include the drive device 40 that supports one end portion of the back door 30 in the vehicle width direction, and a gas spring that supports the other end portion of the back door 30 in the vehicle width direction. The gas spring includes, for example, a cylinder, a piston rod, and a high-pressure gas sealed between the cylinder and the piston rod. In such a vehicle 10, since the back door 30 is more likely to descend when the gas spring comes off, an effect of the door control device 60 becomes remarkable.

The drive device 40 may include the motor 43, a first arm and a second arm to which power of the motor 43 is transmitted, and an electromagnetic clutch configured to switch a transmission state of the power from the motor 43 to the first arm, and the first arm and the second arm may form a link mechanism. In this case, a gas spring that biases the back door 30 in the opening direction is preferably provided between the vehicle body 20 and the back door 30.

The door control device 60 may be applied to a door other than a back door as long as the door rotates about a rotation axis extending along an upper edge of a door opening of a vehicle body.

[Aspect 1] A vehicle door control device is provided that is applied to a vehicle including a door and a drive device, the door being configured to open and close a door opening of a vehicle body by rotating about a rotation axis extending along an upper edge of the door opening, and the drive device including a motor configured to drive the door to open and close, the vehicle door control device controlling driving of the motor. A door opening degree between a door opening degree of the door in a fully open state and a door opening degree of the door in a fully closed state is defined as a determination opening degree. The vehicle door control device executes door control processing when the door moves in a closing direction from a stopped state in a state where a closing operation command signal for commanding a closing operation of the door is not received. In the door control processing, the vehicle door control device executes a braking mode, in which a braking force is applied to the door by regenerative braking action of the motor, when the door opening degree is less than the determination opening degree, and executes a closing operation mode, in which the door performs the closing operation such that a moving speed of the door is constant, when the door opening degree is equal to or greater than the determination opening degree.

According to the above configuration, when the door opening degree is less than the determination opening degree, the braking force is applied to the door moving in the closing direction. Therefore, it is possible to prevent the door from continuously moving in the closing direction about the rotation axis in the state where the closing operation command signal is not input to the door control device, that is, to prevent the door from continuously descending. Accordingly, safety of the surroundings during descending of the door can be secured.

When the door opening degree is equal to or greater than the determination opening degree, the door performs the closing operation such that the moving speed thereof is constant. Accordingly, even when an own weight or an external force acts on the door that performs the closing operation, since the door moves in the closing direction at a constant speed, sudden acceleration in the closing direction of the door can be prevented. Accordingly, as compared to a case where a braking force is applied to the door by regenerative braking action of the motor, it is possible to reduce a load acting on the drive device while securing the safety of the surroundings during descending of the door.

As described above, by switching a driving mode of the motor using the determination opening degree as a threshold, it is possible to secure the safety of the surroundings during descending of the door and reduce the load acting on the drive device.

[Aspect 2] In the vehicle door control device according to [Aspect 1], a determination speed is set as a determination value of a closing speed of the door during execution of the door control processing, the drive device is configured to bias the door in an opening direction in a state where power supply to the motor is stopped, and in the door control processing, the vehicle door control device executes the closing operation mode when the door opening degree is equal to or greater than the determination opening degree and the closing speed of the door is equal to or greater than the determination speed, and executes a stopping mode, in which the power supply to the motor is stopped, when the door opening degree is equal to or greater than the determination opening degree and the closing speed of the door is less than the determination speed.

According to the above configuration, when the door opening degree is equal to or greater than the determination opening degree and the closing speed of the door is equal to or greater than the determination speed, it is determined highly necessary to prevent acceleration of the descending door, and the door performs the closing operation such that the moving speed thereof is constant. Accordingly, as compared to a case where a braking force is applied to the door by regenerative braking action of the motor, it is possible to reduce a load acting on the drive device while securing the safety of the surroundings during descending of the door.

When the door opening degree is equal to or greater than the determination opening degree and the closing speed of the door is less than the determination speed, it is determined that a force causing the door to descend is small, and the power supply to the motor is stopped. In a state where the power supply to the motor is stopped, the door is biased in the opening direction by the drive device. Therefore, when the force causing the door to descend is smaller than a biasing force of the drive device, a posture of the door is maintained. On the other hand, when the force causing the door to descend is greater than the biasing force of the drive device, the door moves in the closing direction against the biasing force. Accordingly, the load acting on the drive device can be reduced as compared with the case where a braking force is applied to the door by the regenerative braking action of the motor.

As described above, when the door opening degree is equal to or greater than the determination opening degree, the determination speed is set as a threshold, and it is possible to secure the safety of the surroundings during descending of the door and reduce the load acting on the drive device.

[Aspect 3] In the vehicle door control device according to [Aspect 1] or [Aspect 2], when the determination speed is defined as a first determination speed, a second determination speed greater than the first determination speed is set as the determination value, and in the door control processing, the vehicle door control device executes the braking mode when the door opening degree is less than the determination opening degree and the closing speed of the door is equal to or greater than the second determination speed, and executes the stopping mode when the door opening degree is less than the determination opening degree and the closing speed of the door is less than the second determination speed.

According to the above configuration, when the door opening degree is less than the determination opening degree and the closing speed of the door is equal to or greater than the second determination speed, it is determined highly necessary to decelerate the door, and a braking force is applied to the door moving in the closing direction. Therefore, it is possible to prevent the door from continuously descending. Accordingly, the safety of the surroundings during descending of the door can be secured.

When the door opening degree is less than the determination opening degree and the door descending speed is less than the second determination speed, it is determined not so highly necessary to decelerate the door, and the power supply to the motor is stopped. Accordingly, the load acting on the drive device can be reduced as compared with the case where a braking force is applied to the door by the regenerative braking action of the motor.

As described above, when the door opening degree is less than the determination opening degree, the second determination speed is set as a threshold, and it is possible to secure the safety of the surroundings during descending of the door and reduce the load acting on the drive device.

[Aspect 4] In the vehicle door control device according to [Aspect 2] or [Aspect 3], in the door control processing, the vehicle door control device executes the braking mode when the closing speed of the door is equal to or greater than the determination speed in a case where the door moves in the closing direction from a stopped state in a state where the closing operation command signal for commanding a closing operation of the door is not received after any one of the braking mode, the closing operation mode and the stopping mode is executed.

According to the above configuration, the braking force is applied to the door that re-descends from the stopped state after any one of the braking mode, the closing operation mode, and the stopping mode is executed. Therefore, even when the door that is stopped once re-descends due to its own weight, an external force, or the like, it is possible to secure the safety of the surroundings during descending of the door.

[Aspect 5] In the vehicle door control device according to any one of [Aspect 1] to [Aspect 4], the vehicle is provided with a notification unit configured to notify a person around the door that the door control processing is being executed, and the notification unit is operated when the door control processing is being executed.

According to the above configuration, a person around the door is notified that the door control processing is being executed. Therefore, it is possible to alert a person around the door to the door that may move in the closing direction.

According to this disclosure, it is possible to secure safety of the surroundings during descending of a door and reduce a load acting on a drive device.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A vehicle door control device that is applied to a vehicle including a door and a drive device, the door being configured to open and close a door opening of a vehicle body by rotating about a rotation axis extending along an upper edge of the door opening, and the drive device including a motor configured to drive the door to open and close, the vehicle door control device controlling driving of the motor, wherein
in a case where a door opening degree between a door opening degree of the door in a fully open state and a door opening degree of the door in a fully closed state is defined as a determination opening degree,
the vehicle door control device executes door control processing when the door moves in a closing direction from a stopped state in a state where a closing operation command signal for commanding a closing operation of the door is not received, and
in the door control processing, the vehicle door control device
executes a braking mode, in which a braking force is applied to the door by regenerative braking action of the motor, when the door opening degree is less than the determination opening degree, and
executes a closing operation mode, in which the door performs the closing operation such that a moving speed of the door is constant, when the door opening degree is equal to or greater than the determination opening degree.

2. The vehicle door control device according to claim 1, wherein
a determination speed is set as a determination value of a closing speed of the door during execution of the door control processing,
the drive device is configured to bias the door in an opening direction in a state where power supply to the motor is stopped, and
in the door control processing, the vehicle door control device
executes the closing operation mode when the door opening degree is equal to or greater than the determination opening degree and the closing speed of the door is equal to or greater than the determination speed, and
executes a stopping mode, in which the power supply to the motor is stopped, when the door opening degree is equal to or greater than the determination opening degree and the closing speed of the door is less than the determination speed.

3. The vehicle door control device according to claim 2, wherein
when the determination speed is defined as a first determination speed, a second determination speed greater than the first determination speed is set as the determination value, and
in the door control processing, the vehicle door control device
executes the braking mode when the door opening degree is less than the determination opening degree and the closing speed of the door is equal to or greater than the second determination speed, and
executes the stopping mode when the door opening degree is less than the determination opening degree and the closing speed of the door is less than the second determination speed.

4. The vehicle door control device according to claim 2, wherein
in the door control processing, the vehicle door control device executes the braking mode when the closing speed of the door is equal to or greater than the determination speed in a case where the door moves in the closing direction from a stopped state in a state where the closing operation command signal for commanding a closing operation of the door is not received after any one of the braking mode, the closing operation mode and the stopping mode is executed.

5. The vehicle door control device according to claim 3, wherein
in the door control processing, the vehicle door control device executes the braking mode when the closing speed of the door is equal to or greater than the determination speed in a case where the door moves in the closing direction from a stopped state in a state where the closing operation command signal for commanding a closing operation of the door is not received after any one of the braking mode, the closing operation mode and the stopping mode is executed.

6. The vehicle door control device according to claim 1, wherein
the vehicle is provided with a notification unit configured to notify a person around the door that the door control processing is being executed, and
the notification unit is operated when the door control processing is being executed.
